(19) United States
(12) Patent Application Publication
(10) Pub. No.: US 2010/0008479 A1
(43) Pub. Date: Jan. 14, 2010

(54) METHOD AND APPARATUS FOR GENERATING COMMISSIONS FROM E-COMMERCE TRANSACTION ASSISTANCE

(76) Inventors: Samuel Cho, Fremont, CA (US); Oon-Gil Paik, Irvine, CA (US)

Correspondence Address: Invent Capture, LLC, 3319 Foxtail Terrace, Fremont, CA, 94536, US

(21) Appl. No.: 12/563,104

(22) Filed: Sep. 18, 2009

Related U.S. Application Data
(63) Continuation-in-part of application No. 11/856,726, filed on Sep. 18, 2007.
(60) Provisional application No. 61/098,124, filed on Sep. 18, 2008.

(51) Int. Cl. H04M 1/64; G06Q 30/00; G06Q 20/00; G06Q 40/00; H04M 11/00; G06F 3/048

(52) U.S. Cl. 379/88.04; 705/26; 705/40; 705/44; 379/88.16; 715/738

(57) ABSTRACT

Methods and apparatuses are disclosed for generating commissions from e-commerce transaction assistance provided by a network-based text-to-speech (TTS) alert system. The network-based text-to-speech (TTS) alert system takes a user's textual and/or multimedia input from a user interface to schedule delivery of text-to-speech-converted information as a reminder call to a user once the user's desired time or an event for the reminder delivery is reached. If the delivered reminder call is associated with a particular e-commerce transaction, then the network-based text-to-speech (TTS) alert system is capable of taking a user feedback for authorization of the particular e-commerce transaction over an IVR interface during the reminder call or an online calendar interface. Once and if the user completes the authorization for the particular e-commerce transaction, the text-to-speech (TTS) alert system can charge and collect a sales and/or transaction commission from an e-commerce provider associated with the e-commerce transaction.

### RELATED APPLICATIONS

The present invention claims priority to a U.S. provisional application 61/098,124 filed on Sep. 18, 2008. The present invention is also a continuation-in-part (CIP) filing of a pending U.S. non-provisional application Ser. No. 11/856,726 filed on Sep. 18, 2007.

### BACKGROUND

This invention generally relates to a voice reminder system. More specifically, the invention relates to a computer network-based text-to-speech voice reminder system operatively connected to a telephone or cellular network for transmission of text-to-speech voice messages and other information to a telephone call recipient.

This invention generally relates to a voice reminder system. More specifically, the invention relates to a computer network-based text-to-speech voice reminder system operatively connected to a telephone or cellular network for transmission of text-to-speech voice messages and other information to a telephone call recipient.

Internet Protocol telephony, or IP telephony, has become a popular application of computer network usage in recent years. Empowered and enabled by voice-over-IP technology (i.e. VoIP), IP telephony transmits voice information as a stream of typically-digitized data packets carried at a network layer (i.e. internet protocol layer). This stream of data packets is re-assembled and converted as analog voice at a packet destination.

Conventional and existing applications of IP telephony primarily involve voice-to-voice communications in real-time. Companies such as Net2Phone and Skype provide commercially-scalable IT infrastructure to support telephone calls over the Internet. IP telephony can further be utilized to provide conventional phone-to-phone communications instead of IP telephony for computer systems and networked devices.

A great business potential and communication efficiency may be realized if IP telephony is further intricately integrated to electronic transactions, Internet services, and/or other business applications beyond a simple voice-to-voice VoIP applications currently enabled by VoIP providers such as Skype and Net2Phone. The present invention captures novel concepts for integrated applications of IP telephony, electronic transactions, and online services.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a method for generating sales and/or transaction commissions for a purchase reminder provider is disclosed. This method comprises the steps of enabling a consumer to schedule a future purchase of an item from an e-commerce provider; allowing the consumer to designate a method of payment during a process of scheduling the future purchase of the item from the e-commerce provider, wherein the method of payment includes a credit card, a saved credit card number in the e-commerce provider, a PayPal account, and/or another method of payment; giving the consumer an option to select a particular date and time or a dynamic event for a delivery of a text-to-speech (TTS) purchase reminder phone call; and taking product-related and price-related information for the item from the e-commerce provider to calculate the sales and/or transaction commissions configured to be charged to the e-commerce provider, wherein the sales and/or transaction commissions are charged to the e-commerce provider if the consumer utilizes or benefits from the text-to-speech (TTS) purchase reminder phone call to authorize, authenticate, and/or complete a purchase transaction of the item.

Furthermore, in another embodiment of the invention, a method for generating sales and/or transaction commissions for a purchase reminder voice phone call provider and/or an online calendar provider is disclosed. This method comprises the steps of enabling a consumer to schedule a future purchase of an item from an e-commerce provider; allowing the consumer to designate a method of payment during a process of scheduling the future purchase of the item from the e-commerce provider, wherein the method of payment includes a credit card, a saved credit card number in the e-commerce provider, a PayPal account, or another method of payment; giving the consumer a first option to select a particular date and time or a dynamic event for a delivery of a purchase reminder as a voice phone call by the purchase reminder voice phone call provider; giving the consumer a second option to place the purchase reminder as an entry to an online calendar provided by the online calendar provider, wherein the entry includes a hyperlink to an Internet storefront of the e-commerce provider; and taking product-related and price-related information for the item from the e-commerce provider to calculate the sales and/or transaction commissions configured to be charged to the e-commerce provider, wherein the sales and/or transaction commissions are charged to the e-commerce provider if the consumer utilizes or benefits from the purchase reminder as the voice phone call or as the entry to the online calendar to authorize, authenticate, and/or complete a purchase transaction of the item.

### BRIEF DESCRIPTION OF DRAWINGS

FIG. 1 shows a first flowchart for an embodiment of the invention.

FIG. 2 shows a screenshot of a first software application using an embodiment of the invention.

FIG. 3 shows another screenshot of the first software application using an embodiment of the invention.

FIG. 4 shows another screenshot of the first software application using an embodiment of the invention.

FIG. 5 shows a screenshot of a second software application using an embodiment of the invention.

FIG. 6 shows another screenshot of the second software application using an embodiment of the invention.

FIG. 7 shows another screenshot of the second software application using an embodiment of the invention.

FIG. 8 shows a second flowchart for an embodiment of the invention.

FIG. 9 shows a screenshot of a third software application using an embodiment of the invention.

FIG. 10 shows a screenshot of the third software application using an embodiment of the invention.

FIG. 11 shows a system configuration diagram in accordance with an embodiment of the invention.

FIG. 12 shows a first subset of the system configuration diagram in accordance with an embodiment of the invention.

FIG. 13 shows a second subset of the system configuration diagram in accordance with an embodiment of the invention.

FIG. 14 shows a flowchart for a method of generating sales and/or transaction commissions for a TagToe reminder provider from e-commerce transaction assistance in accordance with an embodiment of the invention.

FIG. 15 shows a flowchart for a method of generating sales and/or transaction commissions for a TagToe reminder provider and/or a TagToe-linked online calendar provider from e-commerce transaction assistance in accordance with an embodiment of the invention.

FIG. 16 shows a screenshot exhibiting a synergy between a TagToe-linked calendar and a TagToe reminder system in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of procedures, logic blocks, processing, and other symbolic representations that directly or indirectly resemble methods for generating sales and/or transaction commissions from e-commerce transaction assistance and various voice reminder applications in e-commerce. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

In general, embodiments of the invention relate to a voice reminder system using VoIP. In particular, the invention relates to methods for generating sales and/or transaction commissions from e-commerce transaction assistance for a TagToe reminder provider. Furthermore, the invention also relates to various voice reminder applications in e-commerce, in accordance with one or more embodiments of the invention.

Even with ubiquity of the Internet for text-based electronic communication methods such as the world wide web and emails in today's world, voice communications enabled by IP telephony hold some key potential advantages in online scheduling, meeting reminders, e-commerce transaction services, and any other time-sensitive or time-defined services.

For example, conventional e-mail reminders are frequently missed because a computer user may not be sitting in front of a computer accessing a particular web-mail site or an email program. Therefore, an important client-related e-mail meeting reminder may be neglected and forgotten if the computer user either does not have a computer access or forgets to access email box some time prior to the actual meeting time. Likewise, shopping items placed on a “wish list” of an Internet store could be forgotten by a shopper accidentally, which results in substantial loss of “realizable” revenue by the Internet store.

Furthermore, other text-based reminders such as text messages (e.g. SMS) to cell phones are frequently ignored nowadays because numerous marketing text messages or other relevant messages may inundate a cell phone user's text mail box at any given day. Therefore, text-based reminders in form of emails, SMS's, and/or text alerts may be too passive as an alert in some circumstances.

In contrast, if text-to-speech-converted voice reminder services are integrated in a variety of Internet web services to call a cell phone or a landline telephone, they provide unique and novel enablement of proactive reminders and services to call recipients. The passive aspects of text-based reminders, as explained previously, directly contrast the proactive aspects of voice reminder services.

The potential and the promise of integrating text-to-speech-converted voice reminder services to Internet web services are compelling. Observations of human and electronic device interactions suggest that most users are likely to pick up a phone to receive calls if they are present and available. On the other hand, text-based reminders are often too passive as a reminding tool because they are frequently forgotten or neglected at the time of receipt due to a lack of computer access or sometimes a lack of attention.

For the purpose of describing the invention, the term “TagToe” is defined as a time-triggered or a dynamic event-triggered voice alert system which converts at least some textual information to voice data and schedules voice calls to one or more intended recipients at a specified “time trigger” or at a specified “dynamic event”. An example of a “time trigger” is a recipient's self-selected date and time for a scheduled voice reminder call (i.e. a “TagToe reminder”). On the other hand, an example of a “dynamic event” is a lowered price of a product or a service to a recipient's self-selected threshold level (e.g. a laptop computer of the recipient's interest falls to $400, which was the recipient's selected threshold level). TagToe can be used as a standalone web service, as a plug-in application to a plurality of software applications, or as integrated business applications to Internet stores or web portal services.

Furthermore, for the purpose of describing the invention, a term “consumer” is defined as a user or a potential customer of goods and/or services offered by an e-commerce provider.

Moreover, for the purpose of describing the invention, a term “TagToe reminder provider” is defined as an entity providing a “TagToe service,” or a service based on a time-triggered or a dynamic event-triggered voice alert system which converts at least some textual information to voice data and schedules voice calls to one or more intended recipients at a specified time trigger or at a specified dynamic event.

In addition, for the purpose of describing the invention, a term “TagToe reminder” is defined as a voice reminder message based a time-triggered or a dynamic event-triggered voice alert system which converts at least some textual information to voice data and schedules voice calls to one or more intended recipients at a specified time trigger or at a specified dynamic event. One type of a TagToe reminder is a “TagToe purchase reminder,” which is a voice-based purchase reminder message generated by a time-triggered or a dynamic event-triggered voice alert system (i.e. TagToe).

Furthermore, for the purpose of describing the invention, a term “item” is defined as a product and/or a service offered by an e-commerce provider.

The present invention discloses methods for generating profits (i.e. in form of sales and/or transaction commissions) from “TagToe” technology. The present invention also discloses various voice reminder applications in e-commerce using the TagToe technology.

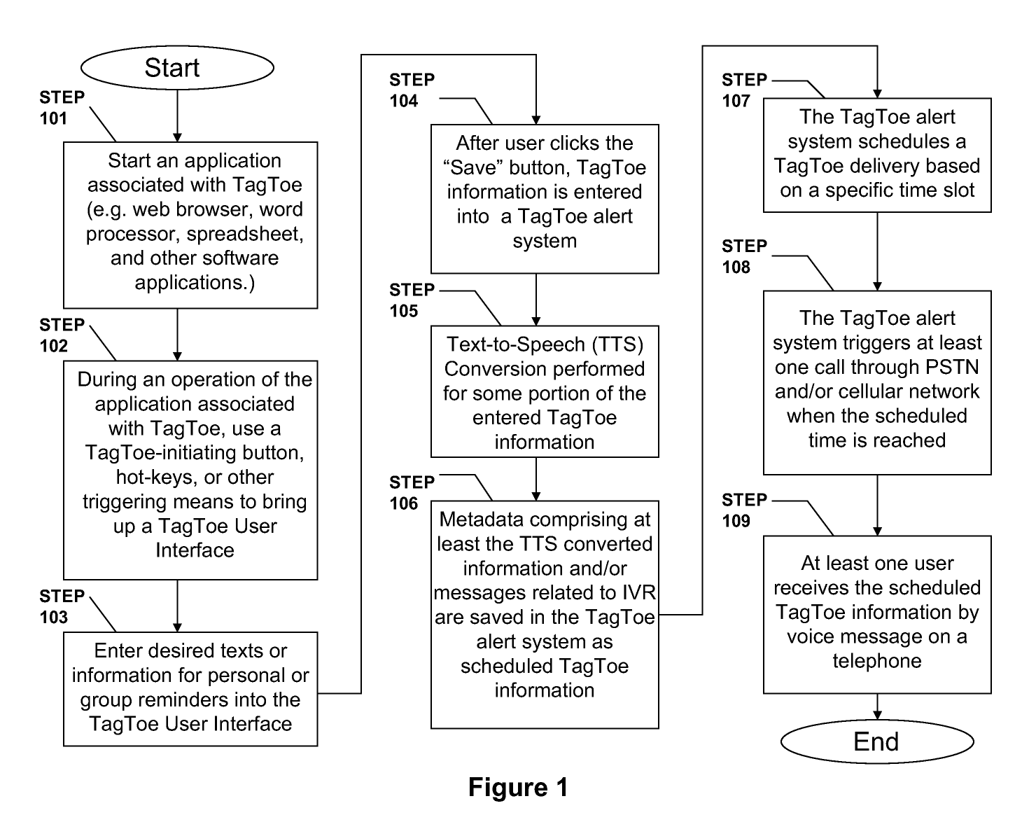

FIG. 1 shows a flowchart for a TagToe-enabled software application operatively connected to a TagToe alert system in accordance with an embodiment of the invention. In this particular embodiment of the invention, a user starts a software application associated with TagToe, as shown in STEP 101. The software application can be a web browser, a word processor program, a spreadsheet program, or any other conventional software applications. Then, during an operation of the software application associated with TagToe, the user can initiate a TagToe reminder by clicking on a TagToe button, a hot-key designated for TagToe, or any other TagToe triggering means to bring up a TagToe user interface, as shown in STEP 102.

In STEP 103, the user enters and/or selects desired texts or a group of information in the TagToe user interface. In one embodiment of the invention, a specific time slot for a TagToe reminder transmission to one or more call recipients is entered or chosen in the TagToe user interface by the user. Then, the user typically clicks an “Okay” or a “Save” button to store the entered and/or the selected information into a data storage in a TagToe alert system, as shown in STEP 104. In one embodiment of the invention, the data storage is a main TagToe reminder server remotely connected to the user's computer via a computer network. In another embodiment of the invention, the data storage is simply a local information storage medium, such as a hard disk or a solid-state non-volatile memory contained in the user's computer.

Continuing with FIG. 1, the TagToe alert system operatively connected to the TagToe-enabled software application performs text-to-speech (TTS) conversion on some or all portions of the entered and/or the selected text information, as shown in STEP 105. Then, in one embodiment of the invention, metadata comprising the text-to-speech converted information and/or other information related to a particular software application, online services, users, or TagToe recipients are saved in the TagToe alert system, as shown in STEP 106. Examples of “other information” related to a particular software application, online services, users, or TagToe recipients include interactive voice response (IVR) which is configured to allow TagToe recipients to make selections for services provided by the particular software application or online services.

In another embodiment of the invention, STEP 106 is simply skipped and only the text-to-speech converted information from STEP 105 is saved in the TagToe alert system as a finalized TagToe reminder for a scheduled call delivery.

After text-to-speech (TTS) conversion and storing of the converted voice data in the TagToe alert system, the TagToe alert system schedules a TagToe delivery based on a specific time slot, as shown in STEP 107. In one embodiment of the invention, the specified time slot for a TagToe reminder transmission is entered or chosen by the user in STEP 103 and the specified time is fetched by the TagToe alert system to schedule a delivery. Then, in STEP 108, the TagToe alert system triggers at least one call through a public-switched telephone network (PSTN) and/or cellular phone network when a scheduled delivery time is reached. In one embodiment of the invention, the call transmission at least partly uses voice-over-IP (VoIP) technology for TagToe reminder deliveries. In STEP 109, at least one intended recipient receives a TagToe reminder by voice telephone call containing at least some portion of the TagToe information originally entered and/or selected by the user.

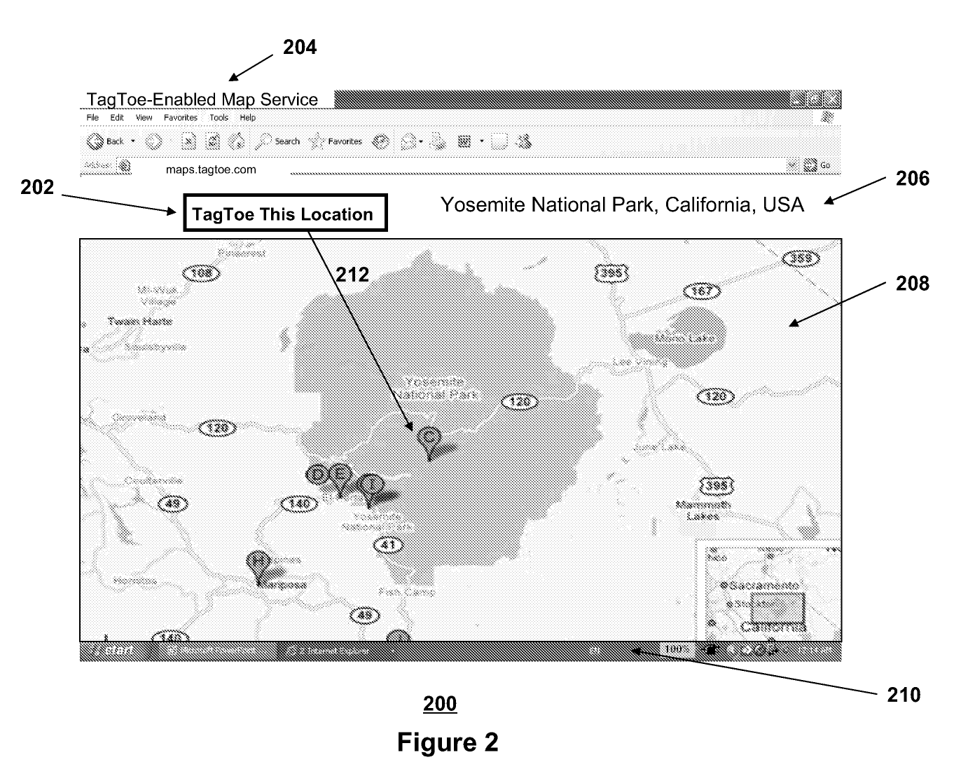

FIG. 2 shows a first screenshot for a first practical example of a TagToe-enabled application utilizing the TagToe alert system. In this example, the TagToe-enabled application is a web browser (200) accessing an online map service site (204). In one embodiment of the invention, the web browser (200) is running within a Microsoft Windows operating system environment (210). A TagToe-initiating button (202) is embedded in the online map service site (204) or embedded in the web browser (200) itself as a plug-in application. The online map service site (204) is currently showing vicinities surrounding Yosemite National Park in California, as shown by the map location indicator (206). The map area field (208) contains many points of interest, roads, geographic designations, and other relevant information.

In the first screenshot, the TagToe-initiating button (202) is pointing to a point of interest “C” by using an arrow (212) in the map area field (208). In one embodiment of the invention, a web browser user can simply move the arrow (212) to a particular point of interest within the map area field (208) to pinpoint a desired location.

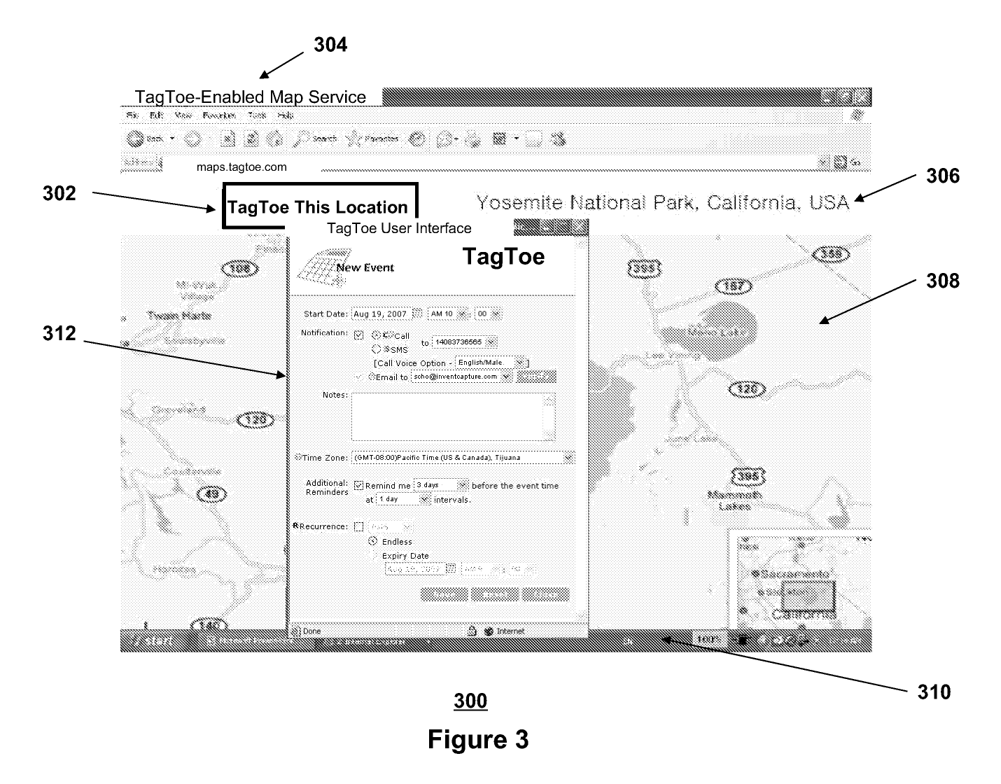

FIG. 3 shows a second screenshot for the first practical example of the TagToe-enabled application utilizing the TagToe alert system. In the second screenshot shown in FIG. 3 following the first screenshot shown in FIG. 2, the web browser user clicks on the TagToe-initiating button (302) to bring a TagToe user interface (312). Because the TagToe-initiating button (302) pointed to the point of interest “C” by using the arrow (212) in the map area field (208) in the first screen, the TagToe user interface (312) automatically integrates geographic information related to the point of interest “C” as a “location to remind people” or as a meeting location.

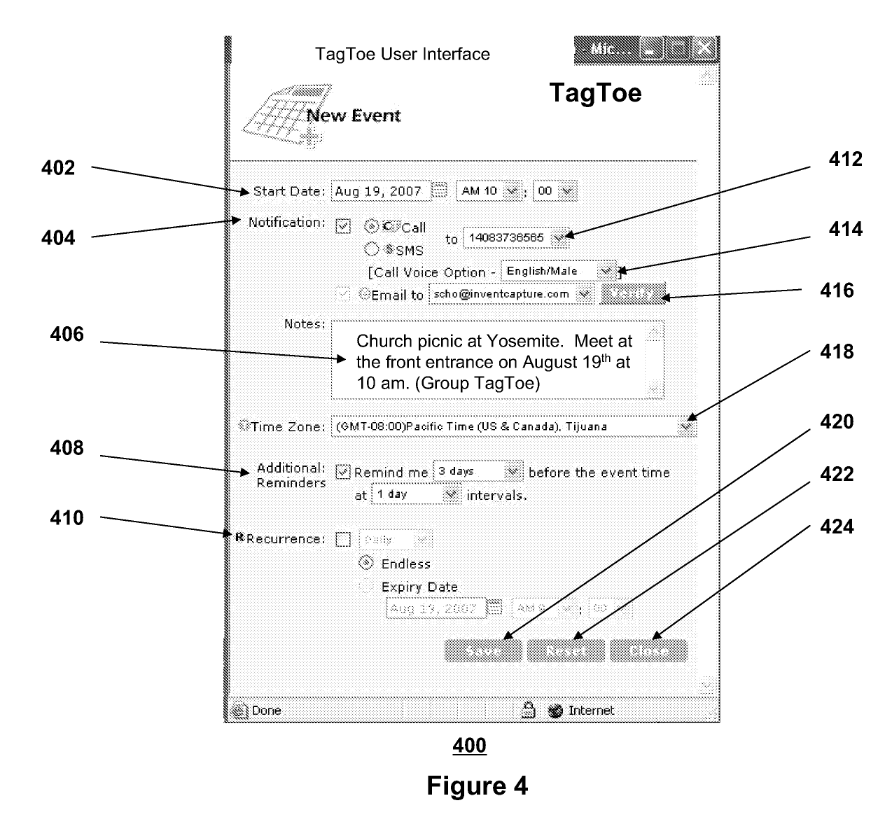

FIG. 4 shows a third screenshot for the first practical example of the TagToe-enabled application utilizing the TagToe alert system. In the third screenshot shown in FIG. 4, an example of detailed fields for the TagToe user interface (400) is displayed. In one embodiment of the invention, the web browser user accessing the online map service site (204) can choose a meeting time or a TagToe reminder time slot (402). The web browser user can also select several modes of reminders, including a TagToe reminder call to an intended recipient (412), an SMS message, or an email. More than one recipient can receive a variety of different types of reminders depending on the user input. For TagToe reminder voice options, the web browser user accessing the online map service site (204) can also choose types of voices and languages. In one embodiment of the invention, an internal translation program can translate one language to another during text-to-speech conversion process. Therefore, if a recipient's preferred language profile is Spanish instead of English, then English textual messages originally-entered into a TagToe-enabled application can be converted to a Spanish voice message during the text-to-speech conversion process before the TagToe alert system schedules a TagToe reminder for delivery.

Continuing with FIG. 4, an email verification button (416) ensures that an email notification does not bounce back due to an incorrect email address. In this example, the web browser user enters Church picnic information for a group meeting in Yosemite for a specific time in a text-entry field (406). Information entered into the text-entry field (406) can go through text-to-speech conversion process later for TagToe reminders (i.e. text-to-speech voice message delivery) to one or more desired telephone call recipients.

In the TagToe user interface (400), a time zone field (418) allows the web browser user to use a desired time zone for meeting reminder scheduling and delivery. The web browser user can also add additional reminders (408) by specifying a recurring reminder interval and/or an additional reminder date prior to the meeting time (402). Further field selection for recurring reminders can be made by configuring recurrence fields (410).

Continuing with FIG. 4, the entered and the selected fields can be saved, reset, or closed by using a “Save” button (420), a “Reset” button (422), or a “Close” button (424). In this particular example, if the “Close” button (424) or the “Reset” button (422) is selected, the web browser user may be asked to confirm saving field information prior to closing the TagToe user interface (400).

If the field information is saved through the TagToe user interface (400), the TagToe alert system performs necessary text-to-speech conversion and schedules TagToe reminder deliveries, email notifications, and/or SMS messages to one or more intended recipients. The first practical example of TagToe-enabled application utilizing the TagToe alert system showcases how the online map service site (204) can provide an integrated IP telephony and web service experience to end users. In this particular example, the TagToe technology provides means of text-to-speech (TTS) voice meeting reminders to intended recipients using their telephone numbers. By inherently integrating map location service and its address information to group “TagToe” meeting reminders initiated by at least one web browser user, the online map service site (204) is able to provide an advanced level of proactive location and meeting reminders to TagToe recipients.

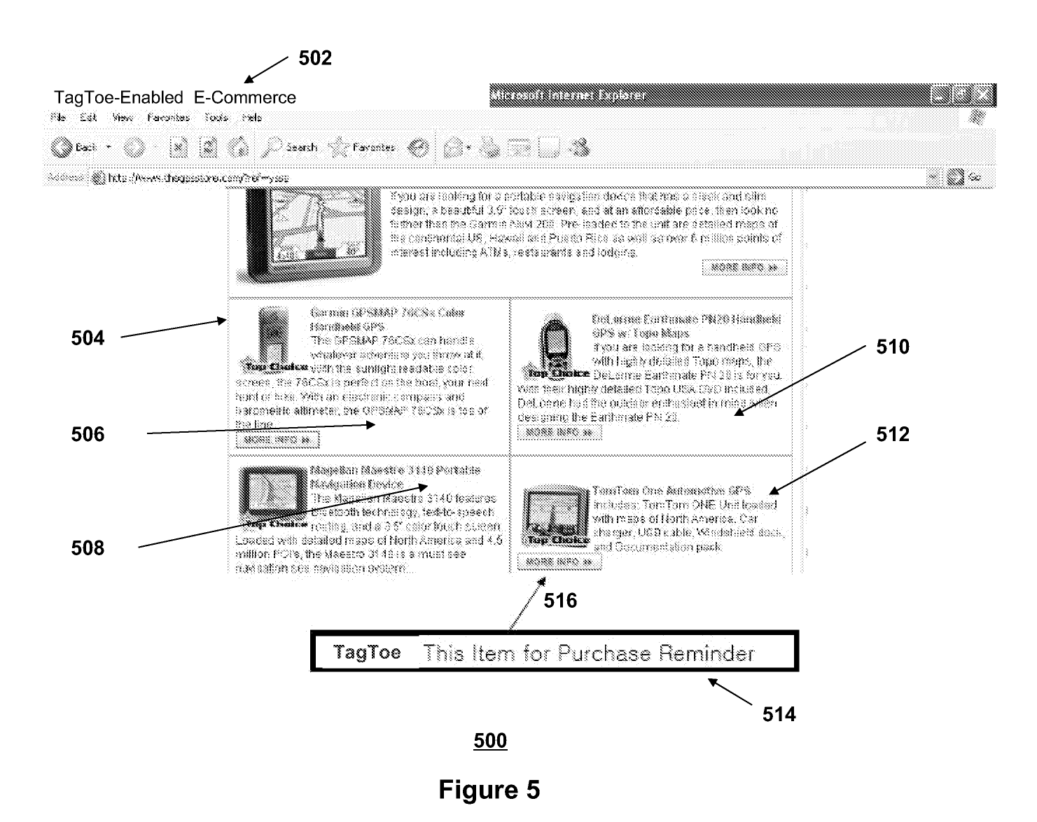

FIG. 5 shows a first screenshot for a second practical example of the TagToe-enabled application utilizing the TagToe alert system. In this example, the TagToe-enabled application is a web browser (500) accessing an online shopping site (502). In one embodiment of the invention, the web browser (500) is running within a Microsoft Windows operating system environment. In this particular example, the online shopping site shows a variety of GPS navigation systems (506, 508, 510, 512) in a online store content page (504).

A TagToe-initiating button (514) is embedded in the online shopping site (502) or embedded in the web browser (500) itself as a plug-in application. The TagToe-initiating button (514) has an arrow (516) to point to a particular product of interest. In this particular case, the user configured the arrow (516) to point to a GPS navigational unit (512). The second practical example showcasing the TagToe technology accommodates a TagToe purchase reminder for the online shopping site (502), which is more proactive than a conventional “wish list” or user-initiated email reminders. By providing proactive user-initiated voice reminders for a future purchase of a product, online stores can achieve substantial revenue increase by integrating the TagToe technology to e-commerce infrastructure. For example, an interactive voice response (IVR) system which is integrated with the TagToe technology and electronic transaction systems can provide a telephonic purchase of the “TagToe-ed” product after a simple identity authentication of a particular call recipient. In another example, the TagToe purchase reminder can be used simply as a self-reminder to a consumer that she or he needs to purchase a product, which motivates the consumer to log-in to an online store correlated to the TagToe purchase reminder to make a purchase.

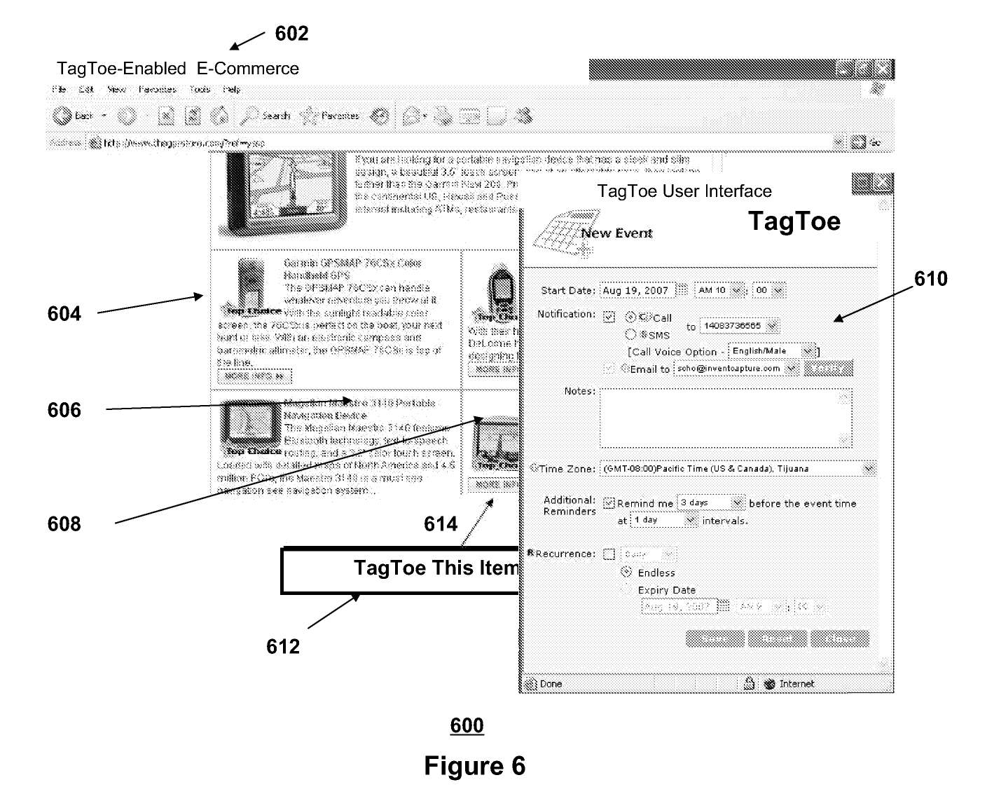

FIG. 6 shows a second screenshot for the second practical example of the TagToe-enabled application utilizing the TagToe alert system. In the second screenshot shown in FIG. 6 following the first screenshot shown in FIG. 5 for the online shopping site (502), the web browser user clicks on a TagToe-initiating button (612) to bring a TagToe user interface (610). Because the TagToe-initiating button (612) pointed to the GPS navigation unit (512) by using the arrow (516) in the online shopping site (502) in FIG. 5, the TagToe user interface (610) automatically integrates product information related to a corresponding GPS navigation unit (608). In FIG. 6, the TagToe-initiating button (612) points to the corresponding GPS navigation unit (608) with an arrow (614). In one embodiment of the invention, an integration of product information to the TagToe technology in e-commerce IT infrastructure is sufficient to accommodate a rapid and efficient telephone-based purchase (e.g. an IVR system) when an intended call recipient receives a TagToe purchase reminder.

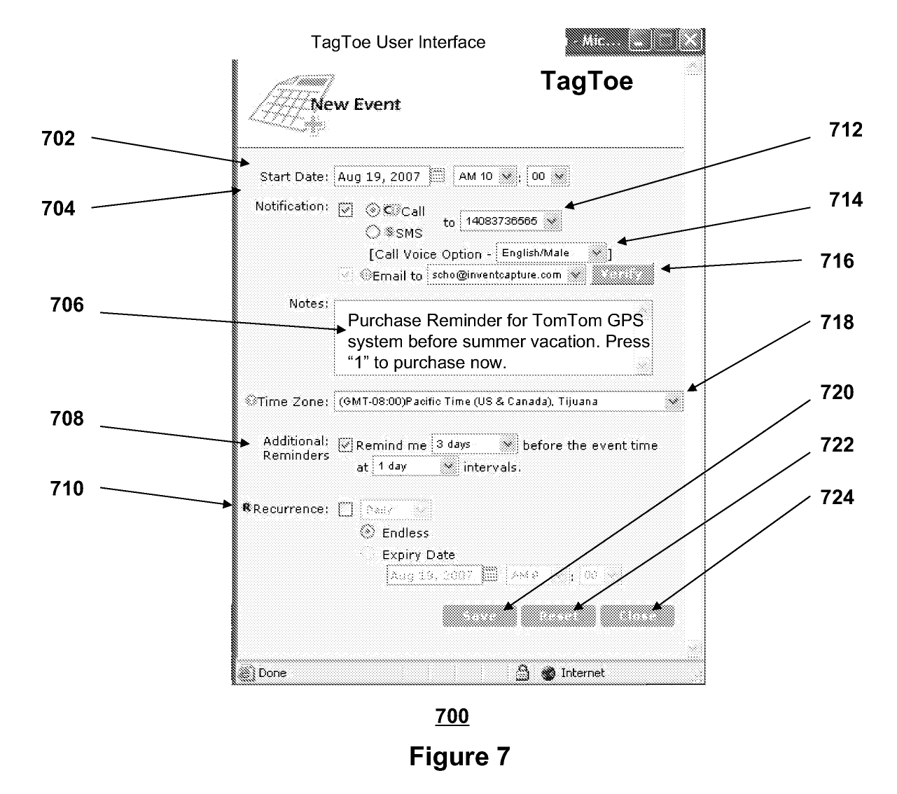

FIG. 7 shows a third screenshot for the second practical example of the TagToe-enabled application utilizing the TagToe alert system. In the third screenshot shown in FIG. 7, an example of detailed fields for the TagToe user interface (700) is displayed. In one embodiment of the invention, the web browser user accessing the online shopping site (502) can choose a future purchase time or a purchase reminder time at a specified time slot (702). The web browser user can also select several modes of reminders, including a TagToe reminder call to an intended recipient (712), an SMS message, or an email. More than one recipient can receive a variety of different types of reminders depending on the user input. In one embodiment of the invention, TagToe purchase reminders generally require pre-TagToe authorizations by intended call recipients to avoid unauthorized telemarketing applications of the TagToe technology. For example, when the web browser user wants to add a telephone number as a TagToe recipient, the TagToe alert system first sends an authorization code to the telephone number for the call recipient authentication and authorization purposes. Other elaborate authentication and/or authorization schemes may be used to protect the privacy of prospective TagToe recipients. For TagToe reminder voice options, the web browser user accessing the online shopping site (502) can also choose types of voices and languages. In one embodiment of the invention, an internal translation program can translate one language to another during text-to-speech (TTS) conversion process. Therefore, if a recipient's preferred language profile is Spanish instead of English, then English textual messages originally-entered into a TagToe-enabled application can be converted to a Spanish voice message during the text-to-speech conversion process before the TagToe alert system schedules a TagToe reminder for delivery.

Continuing with FIG. 7, an email verification button (716) ensures that an email notification does not bounce back due to an incorrect email address. In this example, the web browser user enters a purchase reminder for a desired GPS system before his or her summer vacation for a specific time in a text-entry field (706). Information entered into the text-entry field (706) can go through text-to-speech conversion process later for TagToe reminders (i.e. text-to-speech voice message delivery) to one or more desired telephone call recipients.

In the TagToe user interface (700), a time zone field (718) allows the web browser user to use a desired time zone for meeting reminder scheduling and delivery. The web browser user can also add additional reminders (708) by specifying a recurring reminder interval and/or an additional reminder time prior to the meeting time (702). Further field selection for recurring reminders can be made by configuring recurrence fields (710).

Continuing with FIG. 7, the entered and the selected fields can be saved, reset, or closed by using a “Save” button (720), a “Reset” button (722), or a “Close” button (724). In this particular example, if the “Close” button (724) or the “Reset” button (722) is selected, the web browser user may be asked to confirm saving field information prior to closing the TagToe user interface (700).

If the field information is saved through the TagToe user interface (700), the TagToe alert system performs necessary text-to-speech conversion and schedules TagToe reminder deliveries, email notifications, and/or SMS messages to one or more intended recipients. The second practical example of TagToe-enabled application utilizing the TagToe alert system showcases how the online shopping site (502) can provide an integrated IP telephony and web service experience to end users. In this particular example, the TagToe technology provides means of text-to-speech (TTS) voice purchase reminders to intended recipients using their telephone numbers. In one embodiment of the invention, the TagToe technology is further integrated into the e-commerce IT infrastructure to provide means of immediate telephonic purchase of reminded items when the intended recipients receive TagToe reminders. By inherently integrating an e-commerce infrastructure, product information, and the TagToe technology, the online store site (502) is able to provide an advanced level of proactive purchase reminders and telephonic purchase methods to TagToe recipients.

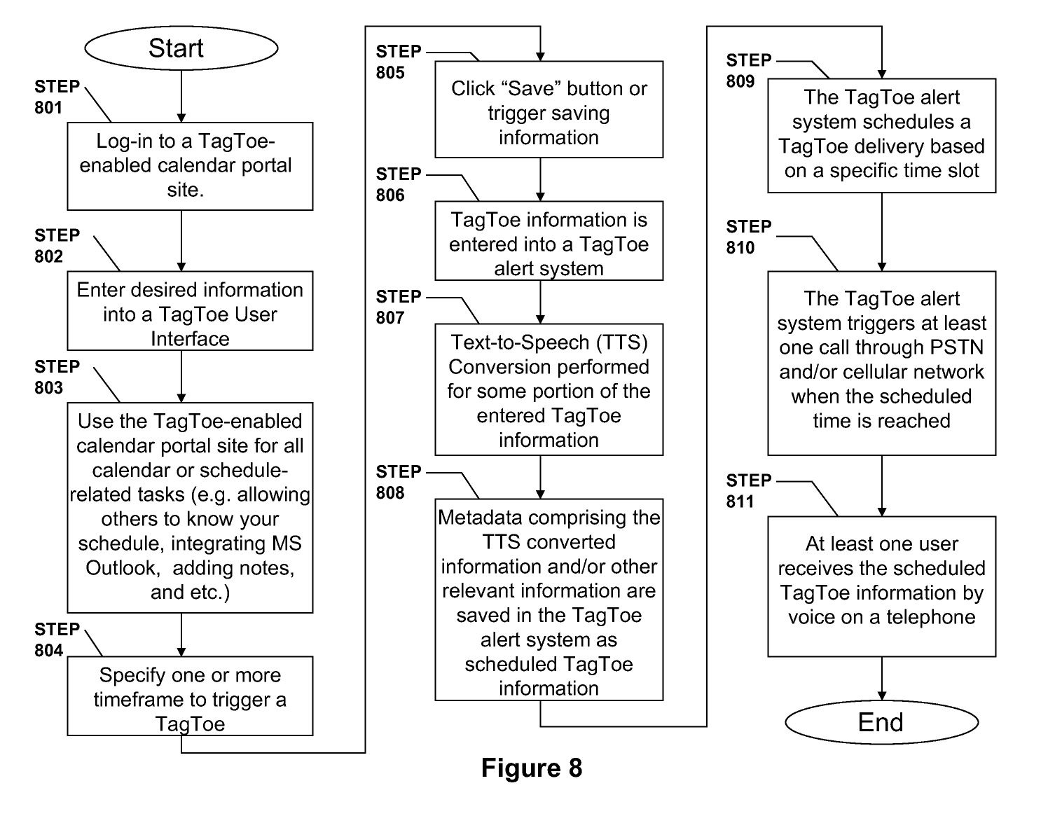

FIG. 8 shows a flowchart for a TagToe-enabled calendar portal site operatively connected to a TagToe alert system in accordance with an embodiment of the invention. This is a preferred embodiment of the invention for the TagToe alert system. In this particular embodiment of the invention, a user logs-in to the TagToe enabled calendar portal site, as shown in STEP 801. Then, the user can either first enter and/or select desired information into a TagToe user interface, as shown in STEP 802, or first use the TagToe-enabled calendar portal site for calendar or scheduling-related tasks, as shown in STEP 803. The order of flow for STEP 802 and STEP 803 is interchangeable (i.e. STEP 803 can precede STEP 802). In one embodiment of the invention, for STEP 802, the user can bring up a TagToe user interface by clicking on a TagToe button, a hot-key designated for TagToe, or any other TagToe user interface triggering means. In another embodiment of the invention, the user can trigger a “new event” from the calendar portal site to bring up a TagToe user interface.

In STEP 802, the user enters and/or selects desired texts or a group of information in the TagToe user interface. In one embodiment of the invention, a specific time slot for a TagToe reminder transmission to one or more call recipients is entered or chosen in the TagToe user interface by the user.

In STEP 803, the user utilizes the TagToe-enabled calendar portal site for calendar or scheduling related tasks. Examples of the calendar or scheduling related tasks include adding notes to one's schedule, configuring schedule-view authorizations for other users, and arranging meetings with others. As stated previously, STEP 803 can precede STEP 802 in some cases. As an optional step, the user can specify one or more timeframe to trigger a TagToe reminder by entering and/or selecting information in the TagToe user interface, as shown in STEP 804.

Then, the user typically clicks an “Okay” or a “Save” button to store the entered and/or the selected information into a data storage in a TagToe alert system, as shown in STEP 805 and STEP 806. In one embodiment of the invention, the data storage is a main TagToe reminder server remotely connected to the user's computer via a computer network. In another embodiment of the invention, the data storage is simply a local information storage medium, such as a hard disk or a solid-state non-volatile memory contained in the user's computer.

Continuing with FIG. 8, the TagToe alert system operatively connected to the TagToe-enabled calendar portal site performs text-to-speech (TTS) conversion on some or all portions of the entered and/or the selected text information, as shown in STEP 807. Then, in one embodiment of the invention, metadata comprising the text-to-speech converted information and/or other relevant information are saved in the TagToe alert system, as shown in STEP 808. Examples of “other relevant information” include interactive voice response (IVR) which is configured to allow TagToe recipients to make selections for available services such as a teleconference call among a plurality of TagToe recipients.

In another embodiment of the invention, STEP 808 is simply skipped and only the text-to-speech converted information from STEP 807 is saved in the TagToe alert system as a finalized TagToe reminder for a scheduled call delivery.

After text-to-speech (TTS) conversion and storing of the converted voice data in the TagToe alert system, the TagToe alert system schedules a TagToe delivery based on a specific time slot, as shown in STEP 809. In one embodiment of the invention, the specified time slot for a TagToe reminder transmission is entered or chosen by the user in STEP 802 and the specified time is fetched by the TagToe alert system to schedule a delivery. Then, in STEP 810, the TagToe alert system triggers at least one call through a public-switched telephone network (PSTN) and/or cellular phone network when a scheduled delivery time is reached. In one embodiment of the invention, the call transmission at least partly uses voice-over-IP (VoIP) technology for TagToe reminder deliveries. In STEP 811, at least one intended recipient receives a TagToe reminder by voice telephone call containing at least some portion of the TagToe information originally entered and/or selected by the user.

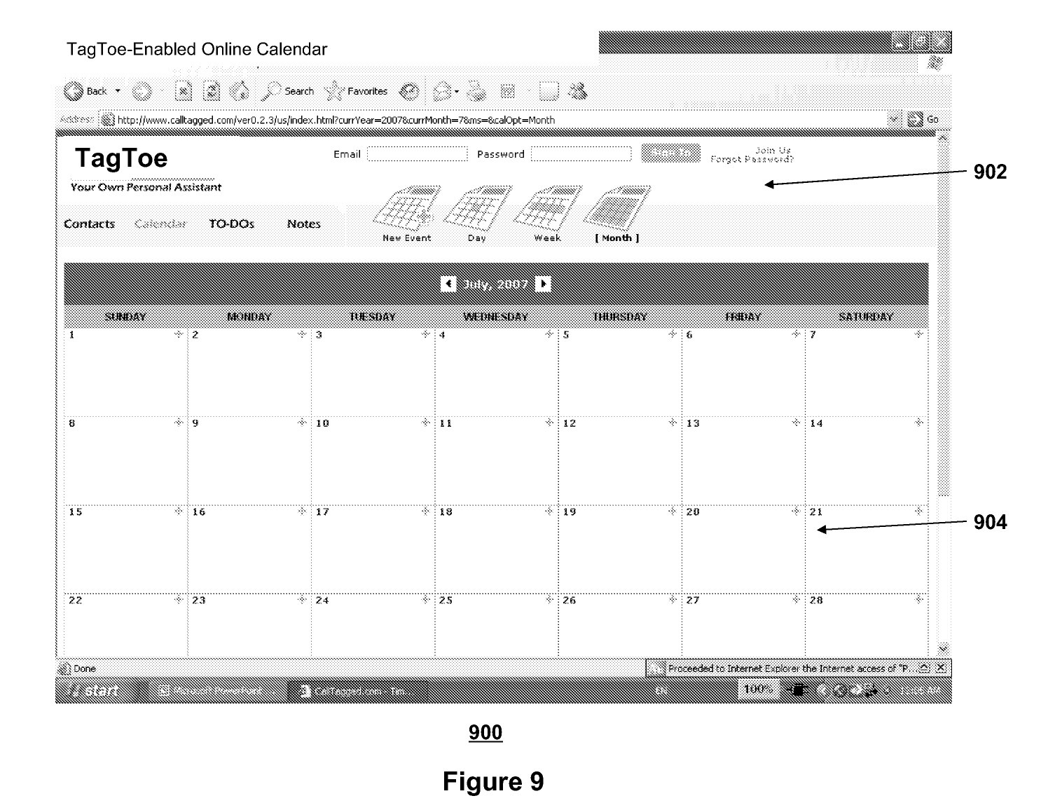

FIG. 9 shows a first screenshot of a TagToe-enabled calendar portal site (900). In one embodiment of the invention, the TagToe-enabled calendar portal site (900) has a menu selection section (902) and an calendar event entry section (904). The menu selection section (902) can contain any features and/or services suitable for online calendar and scheduling functions, including contact lists, note pads, and calendar views by day, week, and month. In one embodiment of the invention, the calendar event entry section (904) opens up a TagToe user interface when a “+” button is clicked on the calendar event entry section.

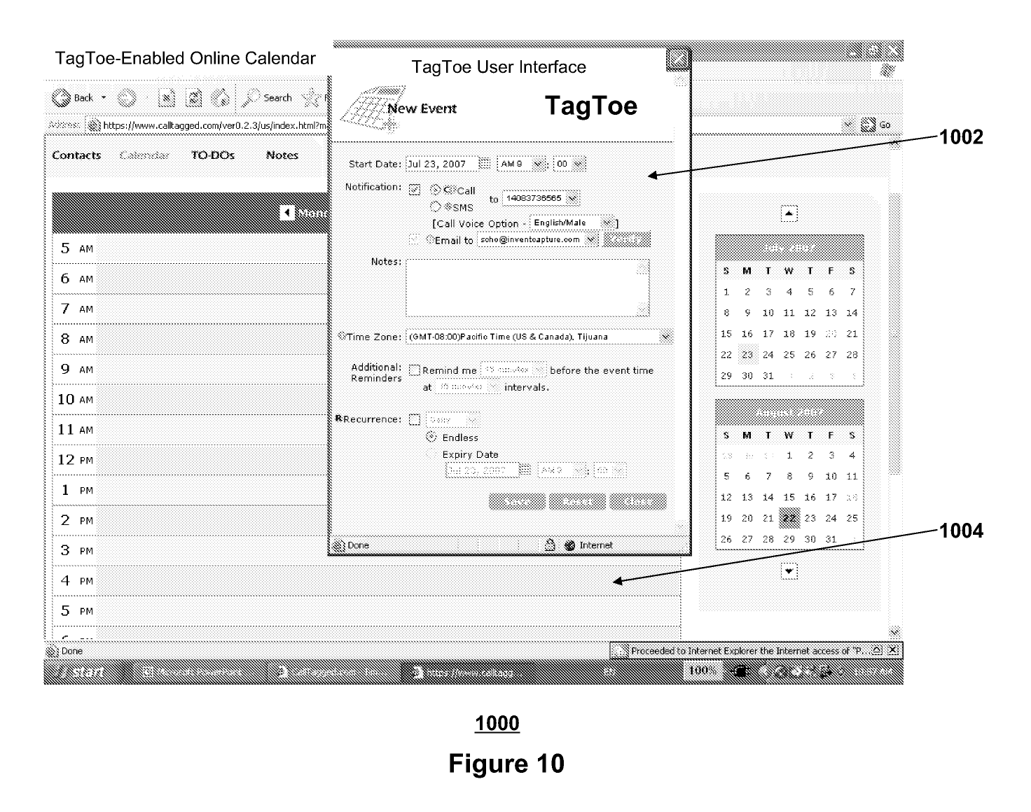

FIG. 10 shows a second screenshot of the TagToe-enabled calendar portal site (1000). In one embodiment of the invention, when a user clicks on the “+” button from the calendar event entry section (904) from FIG. 9, a TagToe user interface (1002) is triggered for entering notes and setting TagToe reminders at a particular time slot. If the user saves entered notes and TagToe reminder settings in the TagToe user interface (1002), a corresponding time slot in the calendar event entry section will reflect the entered notes and/or the TagToe reminder settings. When a scheduled time slot is reached based on the TagToe reminder settings, an TagToe alert system operatively connected to the TagToe-enabled portal site can trigger a telephone call to deliver the entered notes or other relevant online scheduling information to at least one intended TagToe recipients. Intended TagToe recipients typically include the user who wrote and saved notes in the TagToe user interface (1002) for future text-to-speech delivery of the saved notes.

In one embodiment of the invention, the TagToe-enabled calendar portal site is further configured to accommodate conference calls among several TagToe recipients. An interactive voice response (IVR) system can be utilized to give each TagToe recipient an opportunity to participate in one or more conference calls.

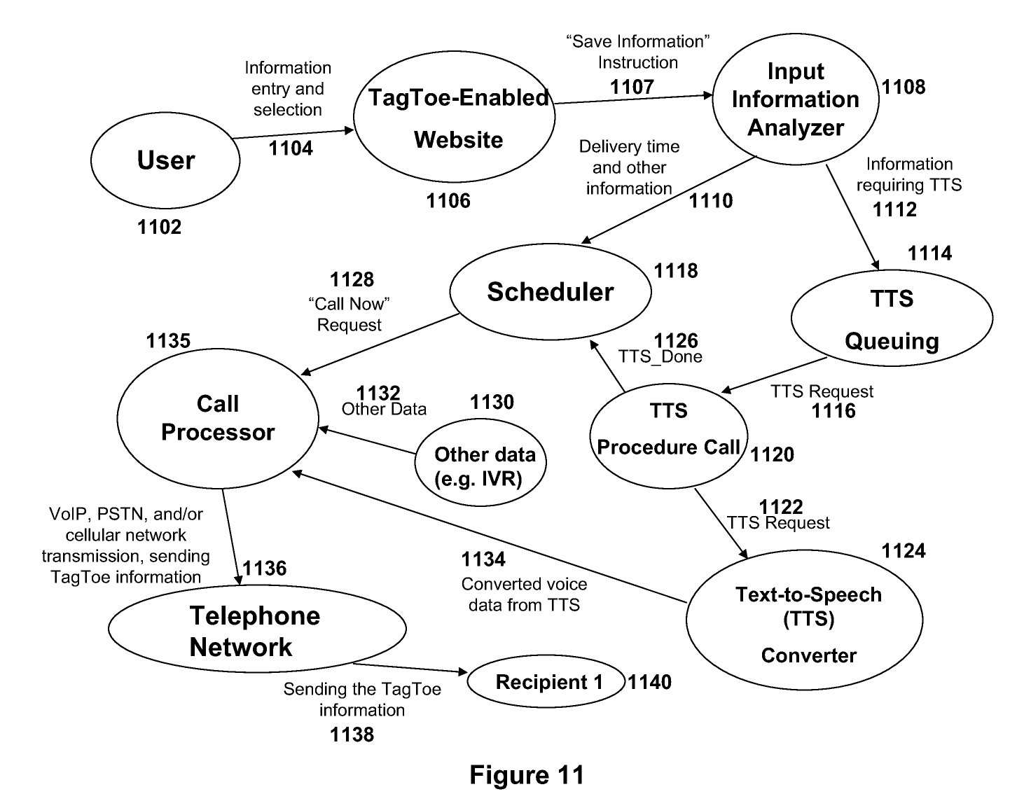

FIG. 11 shows a system configuration diagram for a TagToe alert system in accordance with an embodiment of the invention. In this particular implementation of the invention, a user (1102) enters and/or selects information (1104) on a TagToe-enabled website (1106), typically utilizing a TagToe user interface. When the user (1102) further gives “Save Information” or an equivalent instruction to the TagToe-enabled website (1106) after making entries or selections to the TagToe user interface, an input information analyzer (1108) parses, categorizes, stores, and analyzes the input information (1104) from the user (1102). Then, the input information analyzer (1108) sends delivery time slot(s) and other relevant information (1110) to a TagToe scheduler (1118). The input information analyzer (1108) also sends categorized information (1112) requiring text-to-speech (TTS) conversion to a TTS queuing block (1114). Multiple number of instructions requiring TTS conversion can be queued into the TTS queuing block (1114).

The TTS queuing block (1114) sends a TTS request (1116) to a TTS procedure call (1120). The TTS procedure call (1120) is responsible for “pushing” a TTS request (1122) to a TTS converter (1124), which typically processes TTS requests (1122) serially. It is feasible within this embodiment of the invention that a multiple number of TTS converters is connected to the TagToe alert system for faster parallel processing of TTS conversions.

Continuing with FIG. 11, the TTS procedure call (1120) sends a “TTS_Done” signal (1126) related to a particular TTS conversion to the TagToe scheduler (1118) once the particular TTS conversion is complete. The “TTS_Done” signal (1126) informs that the TagToe scheduler (1118) is now authorized to proceed with a with a “Call Now” request (1128) at a scheduled time slot because the particular TTS conversion related to a TagToe reminder is complete. The TTS converter (1124) is configured to send converted voice data to a call processor (1135) directly. The call processor (1135) also optionally receives “other data” (1132) such as interactive voice response (IVR) data (1130) from e-commerce or customer relationship management IT infrastructures. In one embodiment of the invention, a script language provides IVR data (1132) to the call processor (1135).

The call processor (1135) is capable of gathering call scheduling information from the TagToe scheduler (1118), the TTS converter (1124), and the “other data” block (1130) to make a coherently-organized TagToe telephone call (1138) to at least one intended TagToe recipient (1140) via a telephone network (1136).

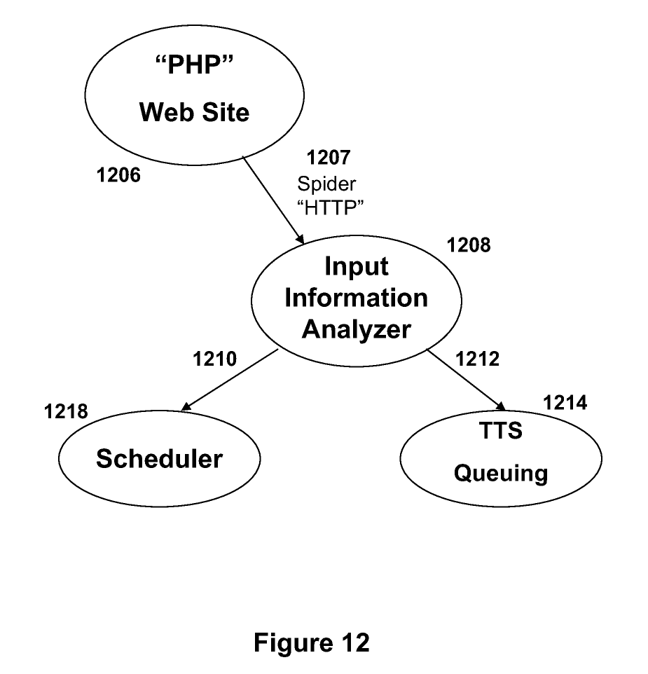

FIG. 12 shows an embodiment of a front-end of a TagToe alert system based on the system configuration diagram of FIG. 11. In this example, a TagToe-enabled website (1106) of FIG. 11 is a “PHP” website (1206) which transmits data to an input information analyzer (1208) by using “HTTP” spiders (1207). The input information analyzer (1208) is capable of parsing, categorizing, storing, and analyzing incoming input information to send appropriately-processed information to a TagToe scheduler (1218) and a TTS queuing block (1214). It should be noted that there are many forms of implementing the front-end of the TagToe alert system and FIG. 12 is merely one example of many possibilities and combinations.

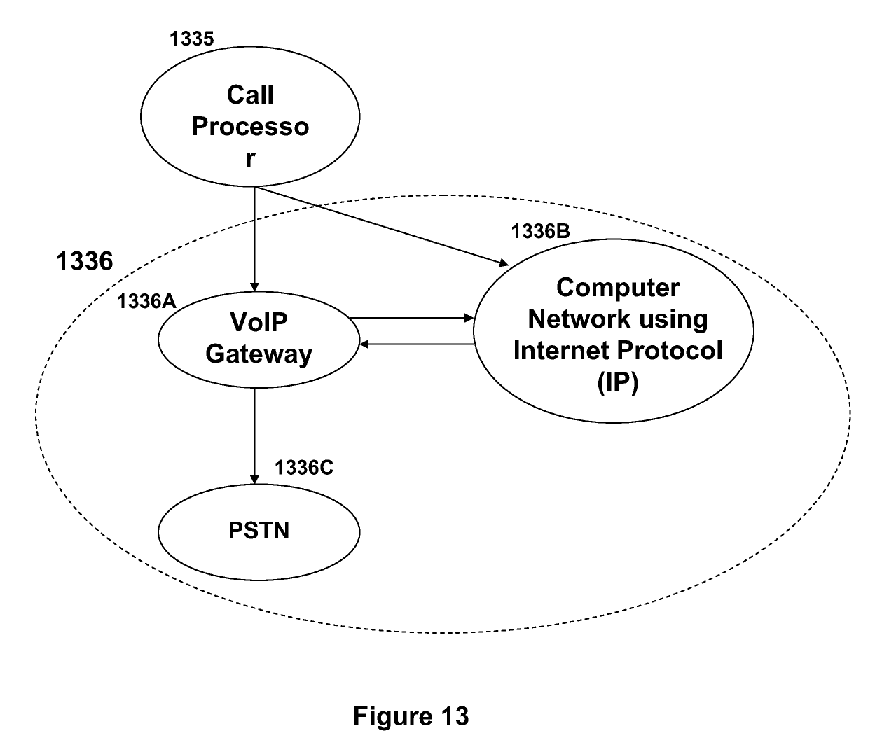

FIG. 13 shows an embodiment of a call processor (1335) and a telephone network (1336) based on the system configuration diagram of FIG. 11. In this example, the telephone network (1136) of FIG. 11 comprises three elements: a voice-over-IP gateway (1336A), a computer network using internet protocol (1336B), and a public-switched telephone network, or PSTN (1336C). In one embodiment of the invention, the voice-over-IP gateway (1336A) acts as an efficient interface between “packetized” IP voice data traveling on the computer network using internet protocol (1136B) and telephone voice data traveling through the public-switched telephone network (1136C). The call processor (1335) can incorporate an internet protocol (IP) or hybrid PBX to switch calls, manage routes, and connect callers with networks outside the internet protocol (IP) infrastructure. In one embodiment of the invention, the call processor (1335) is at least partly implemented with Asterisk, which is an open source telephony platform.

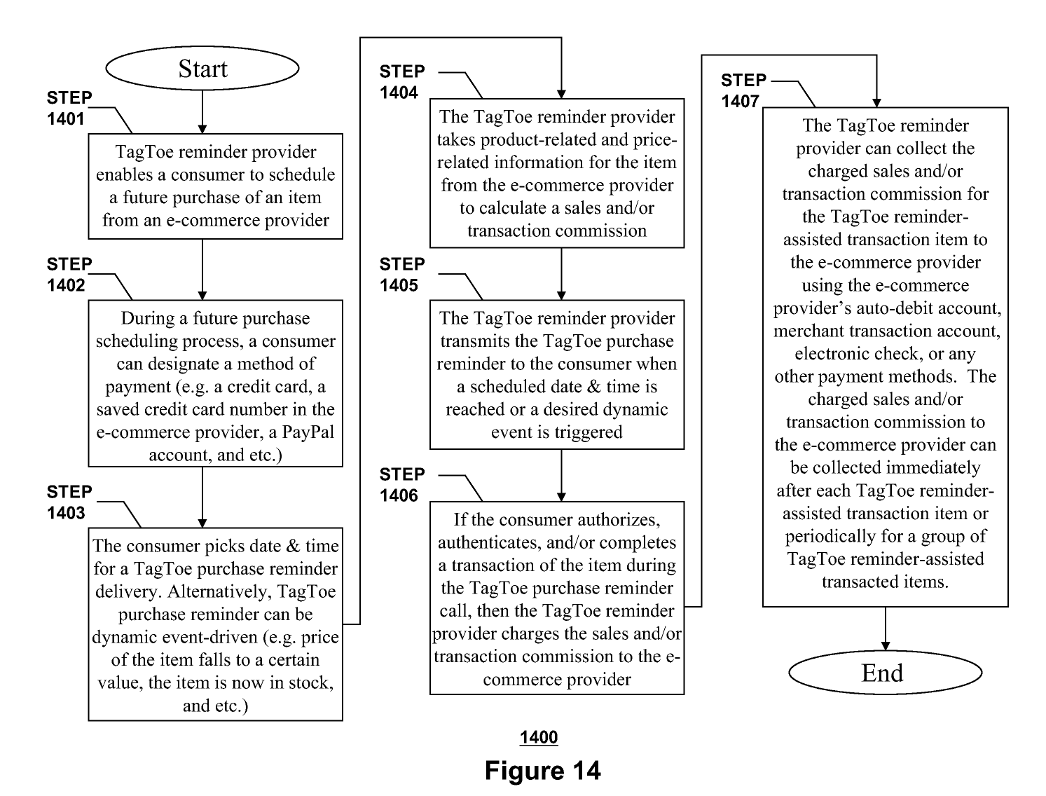

FIG. 14 shows a flowchart (1400) for a method of generating sales and/or transaction commissions for a TagToe reminder provider from e-commerce transaction assistance in accordance with an embodiment of the invention. In a preferred embodiment of the invention incorporating a preferred method of generating sales and/or transaction commissions for the TagToe reminder provider, the TagToe reminder provider enables a consumer (i.e. defined herein as a user or a potential customer of goods and/or services) to schedule an item (i.e. defined herein as a product and/or a service) from an e-commerce provider, as shown in STEP 1401. Examples of e-commerce providers include, but are not limited to, an e-tailor online store, an online auction website, an online service provider, and a business-to-business online market place.

If the consumer decides to schedule the future purchase of a consumer-desired item, then the consumer may have an option to designate a method of payment during the future purchase scheduling process, as shown in STEP 1402. Examples of methods of payment include a consumer's credit card, a consumer's saved credit card number in an e-commerce provider's IT infrastructure, a PayPal account, an electronic check, or other methods of payment usable for electronic transactions.

Continuing with FIG. 14, the consumer can also pick a specific date and time for a TagToe purchase reminder delivery, as shown in STEP 1403. Alternatively or concurrently, the consumer can also select a dynamic event as a trigger to deliver a TagToe purchase reminder, as also shown in STEP 1403. One example of a dynamic event is a falling price of a consumer-desired item to a consumer's specified threshold level. Another example of a dynamic event is an in-stock availability of a consumer-desired item which was previously out-of-stock in the e-commerce provider's storefront.

Once the consumer completes scheduling of the TagToe purchase reminder, the TagToe reminder provider can take product-related and price-related information for the consumer-desired item from the e-commerce provider to calculate a sales and/or transaction commission, as shown in STEP 1404. A specific rate or percentages for sales and/or transaction commission may have been mutually agreed as part of a business partnership between the TagToe reminder provider and the e-commerce provider, in accordance with a preferred embodiment of the invention. For example, the e-commerce provider may have a mutual agreement to give the TagToe reminder provider a two-percent sales and/or transaction commission from a transacted sales price of the consumer-desired item, if the consumer received a TagToe reminder call and used the TagToe reminder's interactive voice response (IVR) feature to complete the transaction during the TagToe reminder call.

Continuing with FIG. 14, in STEP 1405, the TagToe reminder provider transmits the TagToe purchase reminder to the consumer when a scheduled date and time is reached or a desired dynamic event is triggered. In one preferred embodiment of the invention, if the consumer authorizes, authenticates (e.g. password verification), and/or completes a transaction of the consumer-desired item during the TagToe purchase reminder call, then the TagToe reminder provider charges the sales and/or transaction commission to the e-commerce provider, as shown in STEP 1406.

Then, the TagToe reminder provider can collect the charged sales and/or transaction commission for the TagToe reminder-assisted transaction item to the e-commerce provider using the e-commerce provider's auto-debit account, merchant transaction account (e.g. Visa, MasterCard, or American Express merchant account), electronic check account, or any other payment methods in accordance with one preferred embodiment of the invention. The charged sales and/or transaction commission to the e-commerce provider can be collected immediately after each TagToe reminder-assisted transaction item or periodically for a group of TagToe reminder-assisted transaction items, as shown in STEP 1407.

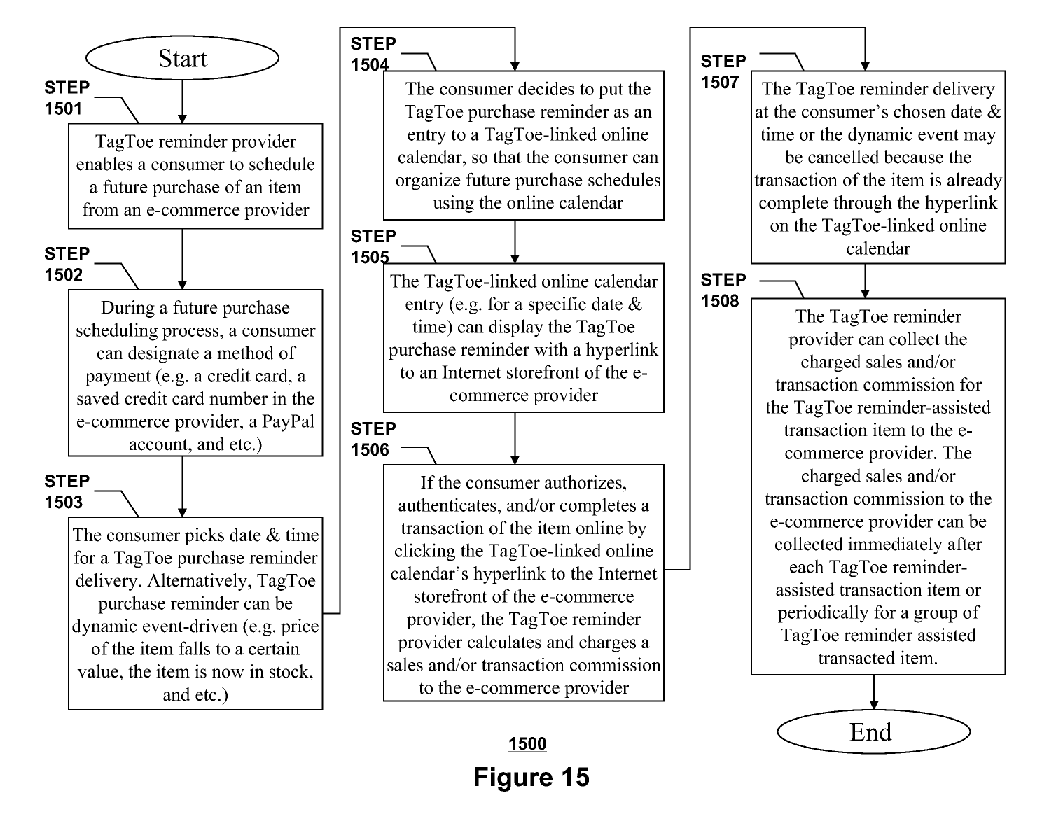

FIG. 15 shows a flowchart (1500) for a preferred method of generating sales and/or transaction commissions for a TagToe reminder provider and/or a TagToe-linked online calendar provider from e-commerce transaction assistance in accordance with an embodiment of the invention. In a preferred embodiment of the invention incorporating a preferred method of generating sales and/or transaction commissions for the TagToe reminder provider and/or the TagToe-linked online calendar provider, the TagToe reminder provider enables a consumer (i.e. defined herein as a user or a potential customer of goods and/or services) to schedule an item (i.e. defined herein as a product and/or a service) from an e-commerce provider, as shown in STEP 1501. Examples of e-commerce providers include, but are not limited to, an e-tailor online store, an online auction website, an online service provider, and a business-to-business online market place.

If the consumer decides to schedule the future purchase of a consumer-desired item, then the consumer may have an option to designate a method of payment during the future purchase scheduling process, as shown in STEP 1502. Examples of methods of payment include a consumer's credit card, a consumer's saved credit card number in an e-commerce provider's IT infrastructure, a PayPal account, an electronic check, or other methods of payment usable for electronic transactions.

Continuing with FIG. 15, the consumer can also pick a specific date and time for a TagToe purchase reminder delivery, as shown in STEP 1503. Alternatively or concurrently, the consumer can also select a dynamic event as a trigger to deliver a TagToe purchase reminder, as also shown in STEP 1503. One example of a dynamic event is a falling price of a consumer-desired item to a consumer's specified threshold level. Another example of a dynamic event is an in-stock availability of a consumer-desired item which was previously out-of-stock in the e-commerce provider's storefront.

The consumer may decide to put the TagToe purchase reminder as an entry to a TagToe-linked online calendar, so that the consumer can organize future purchase schedules using the TagToe-linked online calendar, as shown in STEP 1504. The TagToe-linked online calendar may be used for the consumer's typical calendar and organizer needs, including scheduling/reminding meetings and events. By incorporating a TagToe purchase reminder as a calendar entry, the consumer can effectively organize and optimize his or her future shopping schedules and future shopping budgets.

Continuing with FIG. 15, the TagToe-linked online calendar entry, for a specific date and time, can display the TagToe purchase reminder with a hyperlink to an Internet storefront of the e-commerce provider, as shown in STEP 1505. In one preferred embodiment of the invention, if the consumer clicks on the hyperlink to the Internet storefront of the e-commerce provider at any time during access of the TagToe-linked online calendar, the consumer can efficiently authorize, authenticate, or complete transaction of the consumer-desired item as an Internet-based electronic transaction.

Once the consumer completes scheduling of the TagToe purchase reminder, the TagToe reminder provider and/or the TagToe-linked online calendar provider can take product-related and price-related information for the consumer-desired item from the e-commerce provider to calculate a sales and/or transaction commission. In one preferred embodiment of the invention, a specific rate or percentages for sales and/or transaction commission may have been mutually agreed as part of a business partnership among the TagToe reminder provider, the TagToe-linked online calendar provider, and the e-commerce provider. For example, the e-commerce provider may have a mutual agreement with the TagToe reminder provider and the TagToe-linked online calendar provider to give a one-percent sales and/or transaction commission from a transacted sales price of the consumer-desired item to both TagToe reminder provider and the TagToe-linked online calendar provider, if the consumer uses the hyperlink in the TagToe-linked online calendar to enter the e-commerce provider's online storefront for authorization, authentication, and/or completion of the transaction for the consumer-desired item.

If the consumer authorizes, authenticates (e.g. password verification), and/or completes a transaction of the consumer-desired item through the hyperlink in the TagToe-linked online calendar, then the TagToe reminder provider and/or the TagToe-linked online calendar provider charges the sales and/or transaction commission to the e-commerce provider, as shown in STEP 1506.

Once the transaction of the consumer-desired item is authorized, authenticated, and/or completed via the hyperlink in the TagToe-linked online calendar, the TagToe purchase reminder delivery at the consumer's previously chosen date and time or the dynamic event may be cancelled because the transaction of the consumer-desired item is already complete via the hyperlink, in accordance with one preferred embodiment of the invention as shown in STEP 1507.

Continuing with FIG. 15, the TagToe reminder provider and/or the TagToe-linked online calendar provider can collect the charged sales and/or transaction commission for the TagToe reminder-assisted transaction item to the e-commerce provider using the e-commerce provider's auto-debit account, merchant transaction account (e.g. Visa, MasterCard, or American Express merchant account), electronic check account, or any other payment methods in accordance with one preferred embodiment of the invention. The charged sales and/or transaction commission to the e-commerce provider can be collected immediately after each TagToe reminder-assisted transaction item or periodically for a group of TagToe reminder-assisted transaction items, as shown in STEP 1508.

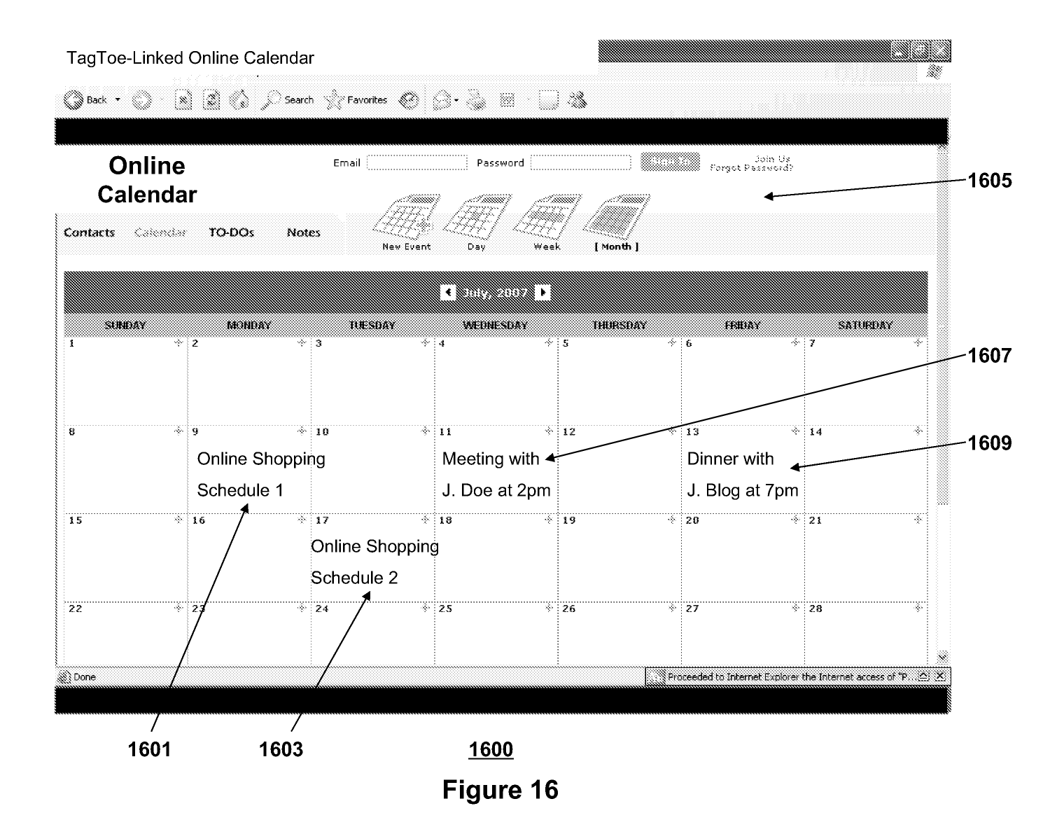

FIG. 16 shows a screenshot (1600) exhibiting a synergy between a TagToe-linked online calendar (1605) and a TagToe reminder system in accordance with an embodiment of the invention. In one preferred embodiment of the invention, one or more online calendar entries (e.g. 1601 and 1603) are purchase reminders, typically containing one or more hyperlinks to an e-commerce storefront. The purchase reminders are also related and linked to TagToe purchase reminders (i.e. purchase reminder voice calls). For example, if a consumer does not purchase a consumer-desired item through a hyperlink in an online calendar entry containing a purchase reminder prior to a date and time correlated to the online calendar entry, then a TagToe purchase reminder is typically delivered to a consumer's specified voice-capable electronic device as a voice reminder call at the date and time correlated to the online calendar entry. On the other hand, if the consumer purchases the consumer-desired item through the hyperlink in the online calendar entry containing the purchase reminder prior to the date and time correlated to the online calendar entry, then the TagToe purchase reminder as the voice reminder call may be cancelled automatically after a purchase transaction for the consumer-desired item is completed through the hyperlink in the online calendar entry.

Continuing with FIG. 16, the TagToe-linked online calendar (1605) is also configured to be used as a regular calendar containing conventional calendar entries such as meeting appointments (e.g. 1607) and lunch/dinner appointments (e.g. 1609), which are typically correlated to desired dates and time. By incorporating TagToe purchase reminders as online calendar entries, the present invention enables a consumer to schedule, anticipate, budget, and transact future shopping items using a TagToe-linked online calendar. Furthermore, by linking TagToe purchase reminders from a TagToe reminder provider to an online calendar provider and an e-commerce provider, the present invention creates a novel and synergistic profit model (e.g. sales and/or transaction commission-based, pay-per-click, and etc.) for the TagToe reminder provider and the online calendar provider while enabling a higher potential sales to actual sales conversion ratio for the e-commerce provider.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating sales and/or transaction commissions for a purchase reminder provider, the method comprising:
enabling a consumer to schedule a future purchase of an item from an e-commerce provider;
allowing the consumer to designate a method of payment during a process of scheduling the future purchase of the item from the e-commerce provider, wherein the method of payment includes a credit card, a saved credit card number in the e-commerce provider, a PayPal account, and/or another method of payment;
giving the consumer an option to select a particular date and time or a dynamic event for a delivery of a text-to-speech (TTS) purchase reminder phone call; and
taking product-related and price-related information for the item from the e-commerce provider to calculate the sales and/or transaction commissions configured to be charged to the e-commerce provider, wherein the sales and/or transaction commissions are charged to the e-commerce provider if the consumer utilizes or benefits from the text-to-speech (TTS) purchase reminder phone call to authorize, authenticate, and/or complete a purchase transaction of the item.

2. The method of claim 1, further comprising a step of delivering the text-to-speech (TTS) purchase reminder phone call to the consumer at the particular date and time or the dynamic event selected by the consumer.

3. The method of claim 1, wherein the step of enabling the consumer to schedule the future purchase of the item from an e-commerce provider involves presenting and utilizing a web user interface for the consumer.

4. The method of claim 3, wherein the web user interface used by the consumer to enter, select, and/or designate the future purchase of the item, the method of payment, and the particular date and time or the dynamic event for the delivery of the text-to-speech (TTS) purchase reminder phone call saves at least some data entered, selected, and/or designated by the consumer.

5. The method of claim 4, wherein the web user interface, which saves at least some data entered, selected, and/or designated by the consumer, is utilized by the purchase reminder provider to create the text-to-speech (TTS) purchase reminder phone call.

6. The method of claim 1, wherein the text-to-speech (TTS) purchase reminder phone call integrates an interactive voice response (IVR) interface to enable the consumer to authorize, authenticate, and/or complete the purchase transaction of the item during the TTS purchase reminder phone call to the consumer.

7. The method of claim 1, wherein the e-commerce provider is an online-based (e.g. Internet) store, an online service provider, and/or an online auction site.

8. The method of claim 1, wherein the text-to-speech (TTS) purchase reminder phone call includes at least some of the product-related and price-related information for the item from the e-commerce provider.

9. The method of claim 1, wherein the text-to-speech (TTS) purchase reminder phone call includes an option to the consumer to either delay or cancel the purchase transaction of the item.

10. The method of claim 1, wherein the text-to-speech (TTS) purchase reminder phone call is delivered to the consumer at the particular date and time or the dynamic event selected by the consumer.

11. The method of claim 1, wherein the sales and/or transaction commissions charged to the e-commerce provider by the purchase reminder provider are collected via an auto-debit account, a merchant transaction account, electronic check, and/or any other payment methods associated with the e-commerce provider.

12. A method for generating sales and/or transaction commissions for a purchase reminder voice phone call provider and/or an online calendar provider, the method comprising:
enabling a consumer to schedule a future purchase of an item from an e-commerce provider;
allowing the consumer to designate a method of payment during a process of scheduling the future purchase of the item from the e-commerce provider, wherein the method of payment includes a credit card, a saved credit card number in the e-commerce provider, a PayPal account, or another method of payment;
giving the consumer a first option to select a particular date and time or a dynamic event for a delivery of a purchase reminder as a voice phone call by the purchase reminder voice phone call provider;
giving the consumer a second option to place the purchase reminder as an entry to an online calendar provided by the online calendar provider, wherein the entry includes a hyperlink to an Internet storefront of the e-commerce provider; and
taking product-related and price-related information for the item from the e-commerce provider to calculate the sales and/or transaction commissions configured to be charged to the e-commerce provider, wherein the sales and/or transaction commissions are charged to the e-commerce provider if the consumer utilizes or benefits from the purchase reminder as the voice phone call or as the entry to the online calendar to authorize, authenticate, and/or complete a purchase transaction of the item.

13. The method of claim 12, wherein the step of giving the consumer the first option to schedule the particular date and time or the dynamic event for the delivery of the purchase reminder as the voice phone call involves presenting and utilizing a web user interface and/or the online calendar for the consumer.

14. The method of claim 13, wherein the web user interface and/or the online calendar used by the consumer to enter, select, and/or designate the future purchase of the item, the method of payment, the first option to select the particular date and time or the dynamic event for the delivery of the purchase reminder as the voice phone call, and/or the second option to place the purchase reminder as the entry to the online calendar saves at least some data entered, selected, and/or designated by the consumer.

15. The method of claim 14, wherein the web user interface and/or the online calendar, which saves at least some data entered, selected, and/or designated by the consumer, is utilized by the purchase reminder provider to create text-to-speech (TTS) voice information for the voice phone call associated with the first option.

16. The method of claim 12, wherein the voice phone call integrates an interactive voice response (IVR) interface to enable the consumer to authorize, authenticate, and/or complete the purchase transaction of the item during the voice phone call to the consumer.

17. The method of claim 12, wherein the e-commerce provider is an online-based (e.g. Internet) store, an online service provider, and/or an online auction site.

18. The method of claim 12, wherein the voice phone call or the entry to the online calendar includes at least some of the product-related and price-related information for the item from the e-commerce provider.

19. The method of claim 12, wherein the purchase reminder voice phone call provider and the online calendar provider are a same entity.

20. The method of claim 12, wherein the sales and/or transaction commissions charged to the e-commerce provider by the purchase reminder provider are collected via an auto-debit account, a merchant transaction account, electronic check, and/or any other payment methods associated with the e-commerce provider.
